(19) United States
(12) Patent Application Publication
(10) Pub. No.: US 2014/0229541 A1
(43) Pub. Date: Aug. 14, 2014

(54) METHOD AND SYSTEM FOR CONTENT MANAGEMENT OF SOCIAL NETWORKING DATA

(71) Applicant: IDEATION INC., New York, NY (US)

(72) Inventors: Robert Anthony DILIO, New York, NY (US); Marc Scott Lotenberg, New York, NY (US)

(21) Appl. No.: 13/835,678

(22) Filed: Mar. 15, 2013

Related U.S. Application Data
(60) Provisional application No. 61/762,667, filed on Feb. 8, 2013.

(51) Int. Cl. H04L 29/06

(52) U.S. Cl. CPC H04L 65/40
USPC 709/204

(57) ABSTRACT

Methods (10, 20, and 50) and systems (200) for managing content include aggregating social networking data from a plurality of social networks on to a website to provide an aggregation of social networking data on a website, curating the aggregation of social networking data, and selectively approving content for display on the website from the aggregation of social networking data. Other embodiments are disclosed.

### CROSS-REFERENCE TO RELATED APPLICATIONS

This application claims the benefit of U.S. Provisional Application No. 61/762,667, filed Feb. 8, 2013, which application is expressly incorporated by reference herein in its entirety.

### FIELD

These embodiments relate generally to methods and systems for content management, and more particularly to content management and curating of social networking data.

### BACKGROUND

Social networking is a new way for communicating and sharing information including media content and information that can influence an audience that can include consumers, advocates, as well as deriders or detractors of a particular brand, product or service. A social network is defined as a web service that enables a user to interact with other users that are trusted. Several services aggregate social networking data and further emphasize the impact of such communication medium. Thus, the proliferation of information on social networks can quickly sway or influence a respective audience without much control from an owner of a brand, service, or product.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled.” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

Each of the embodiments listed above will be described below in further detail with further reference to the attached figures.

FIG. 1 is a flow chart illustrating of a method of content management for a plurality of social networks in accordance with an embodiment of the present disclosure.

FIG. 2 is an illustration of another method of content management for a plurality of social networks in accordance with an embodiment of the present disclosure.

FIG. 3 is continuation of the flow chart of FIG. 2.

FIG. 4 is an illustration of visual mock-ups or screens in accordance with an embodiment of the present disclosure.

FIG. 5 is an illustration of a screenshot of new postings from a particular social network in accordance with an embodiment of the present disclosure.

FIG. 6 illustrates another screenshot enabling curation and approval of content from a particular selected social network in accordance with an embodiment of the present disclosure.

FIG. 7 is illustrates another screenshot enabling curation, editing, and layout set up of content from a particular selected social network in accordance with an embodiment of the present disclosure.

FIG. 8 is a computing device having a memory arrangement and operating in accordance with an embodiment of the present disclosure.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

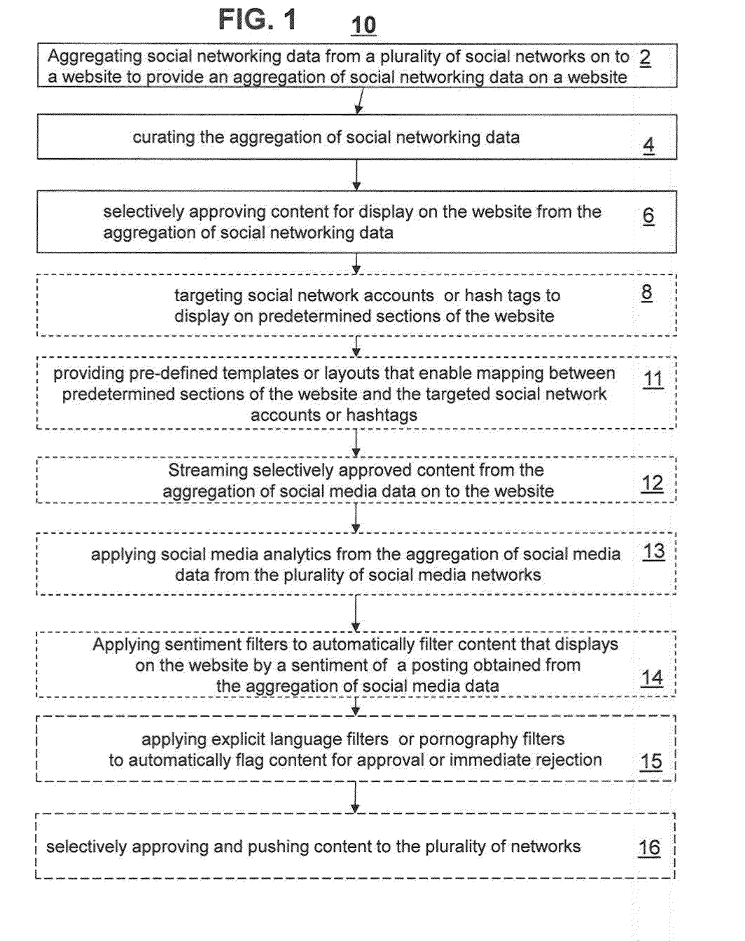

Referring to FIG. 1, a method 10 of managing content includes at step 2 aggregating social networking data from a plurality of social networks on to a website to provide an aggregation of social networking data on a website, curating the aggregation of social networking data at step 4, and selectively approving content for display on the website from the aggregation of social networking data at step 6. The method can further optionally include targeting social network accounts or targeting hash tags to display on predetermined sections of the website at step 8. The method 10 can further provide pre-defined templates or layouts that enable mapping between predetermined sections of the website and the targeted social network accounts or hash tags at step 11. At step 12, the method can further including streaming selectively approved content from the aggregation of social media data on to the website. Further optional steps include applying social media analytics from the aggregation of social media data from the plurality of social media networks at step 13, applying sentiment filters to automatically filter content that displays on the website by a sentiment of a posting obtained from the aggregation of social media data at step 14, or applying explicit language filters or pornography filters to automatically flag content for approval or immediate rejection at step 15. At step 16, the method 100 can also include selectively approving and pushing content to the plurality of networks.

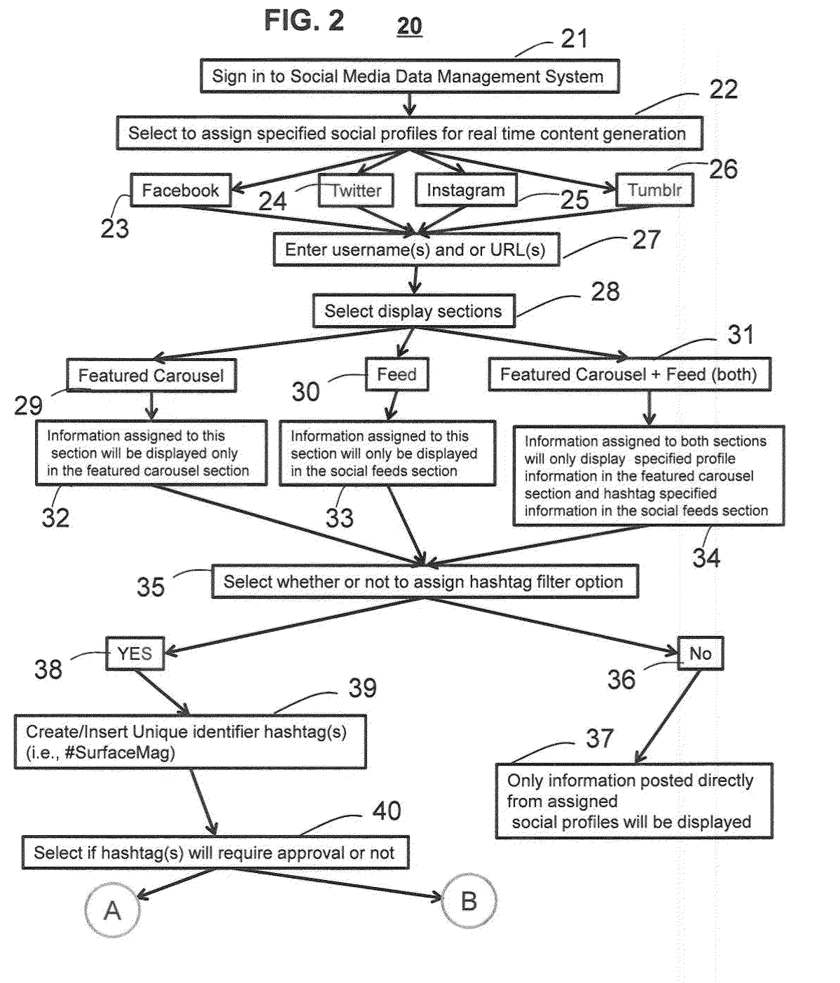

In another embodiment and with reference to FIG. 2, a method 20 of social media content or data management can begin with a user signing in to a social media data management system at 21 and selecting to assign specified social profiles for real-time content generation at 22 from a plurality of social networks such as Facebook 23, Twitter 24, Instagram 25, or Tumblr 26. At 27, respective username(s) and/or URL(s) can be entered and certain display selection can be made at 28. The display selections can be among a featured carousel at 29, a feed at 30 or a combination of a featured carousel and feed at 31 among other display selections. If the featured carousel is selected at 29, then information assigned to this particular selected section will be displayed only in the featured carousel section at 32. If the feed is selected at 30, then information assigned to this particular section will only be displayed in the social feeds section at 33. If both are selected at 31, then the information assigned to both sections will only display specified profile information in the featured carousel section and hash tag specified information will be displayed in the social feeds section at 34. At 35, a selection is made between whether or not to assign a hash tag filter option. If the selection is “no” at 36, then only information posted directly from assigned social profiles will be displayed at 37. If the selection is “yes” at 39, then a unique identifier or hash tag is created and/or inserted at 39. At 40, a designation is selected whether the particular hash tag (from 39) will require approval or not.

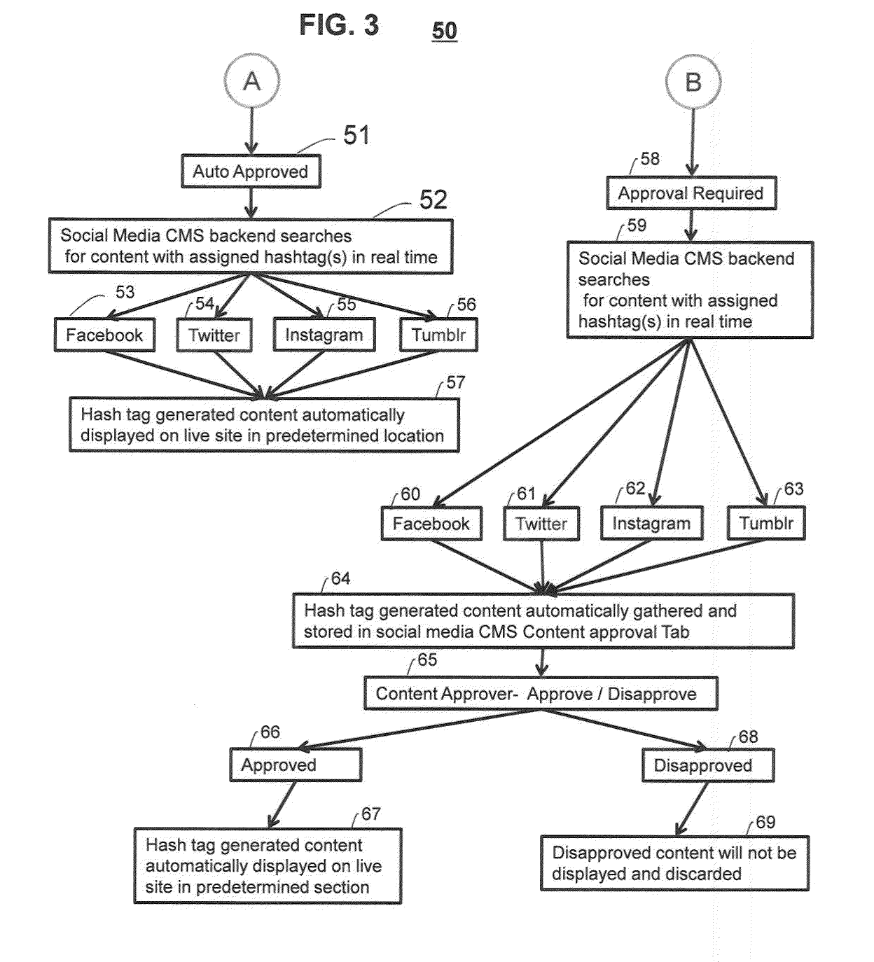

Referring to FIG. 3, the continuation 50 of the flow chart or method 20 from FIG. 2 is shown. If the hash tag is designated to receive automatic approval, the method continues under “A” and the hash tag is automatically approved at 51. At 52, the social media content management system (CMS) backend searches for content with assigned hash tags in real time among social networks 53, 54, 55, and 56 as shown (for example). Then at 57, the hash tag generated content is automatically displayed on a live site in a predetermined location as previously set (at 28). If the hash tag is designated to require approval, the method continues under “B” and the hash tag continues through step 58 and 59 where the social media content management system backend searches for content with assigned hash tags in real time among social networks 60, 61, 62, and 63 as shown (for example). At 64, hash tag generated content is automatically gathered and stored (but not published) and made available for approval at a social media CMS content approval tab. At 65, the authorized content approver either approves or disapproves the content. If the content is approved at 55, then the hash tag generated content is automatically displayed on a live site in a predetermined section at 67. If the content is not approved at 68, then the disapproved content will not be displayed and will be discarded at 69.

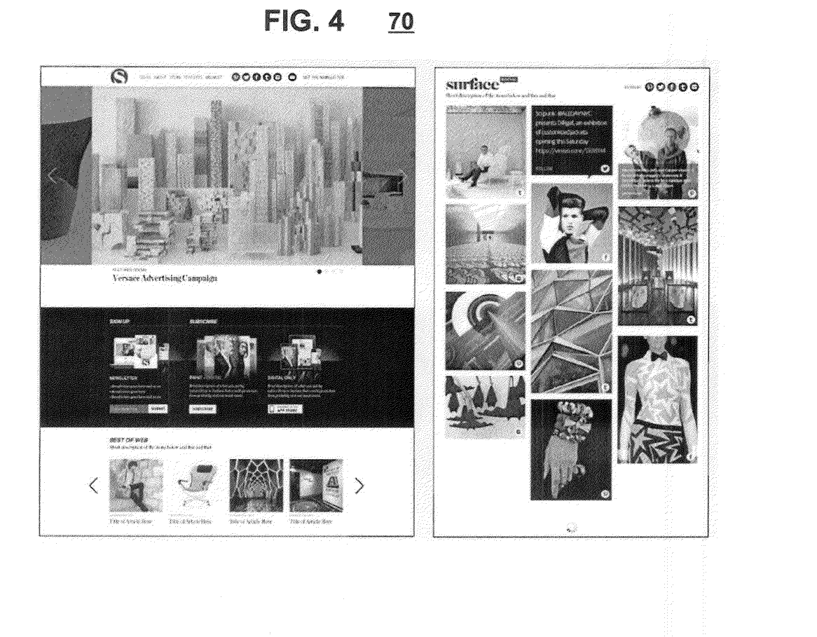

Referring to FIG. 4, sample mock ups or screens 70 of a consolidated or aggregated, curated, and approved website containing content from a plurality of social media networks is illustrated. In this instance the links or hash tags are visual and can provide an indication as the origination of the particular social media content.

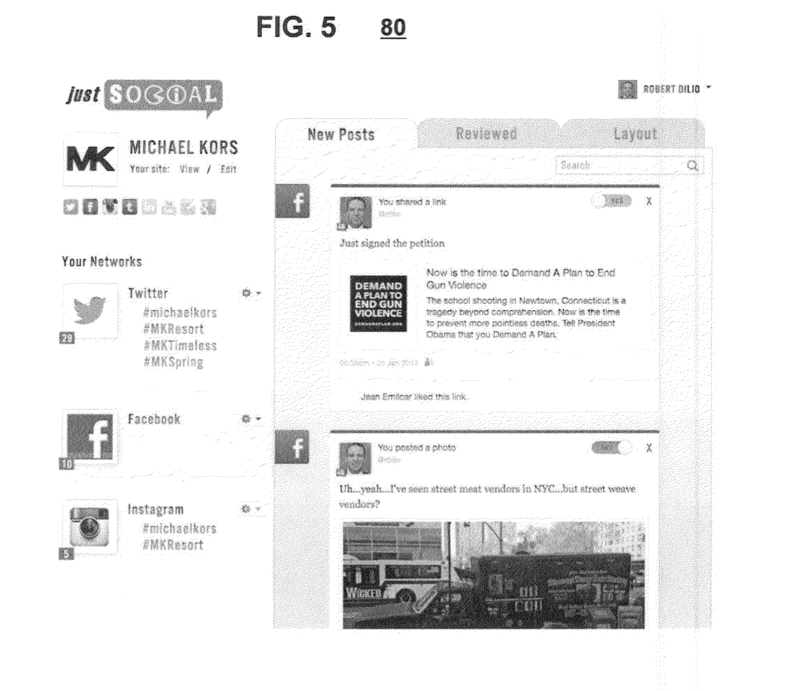

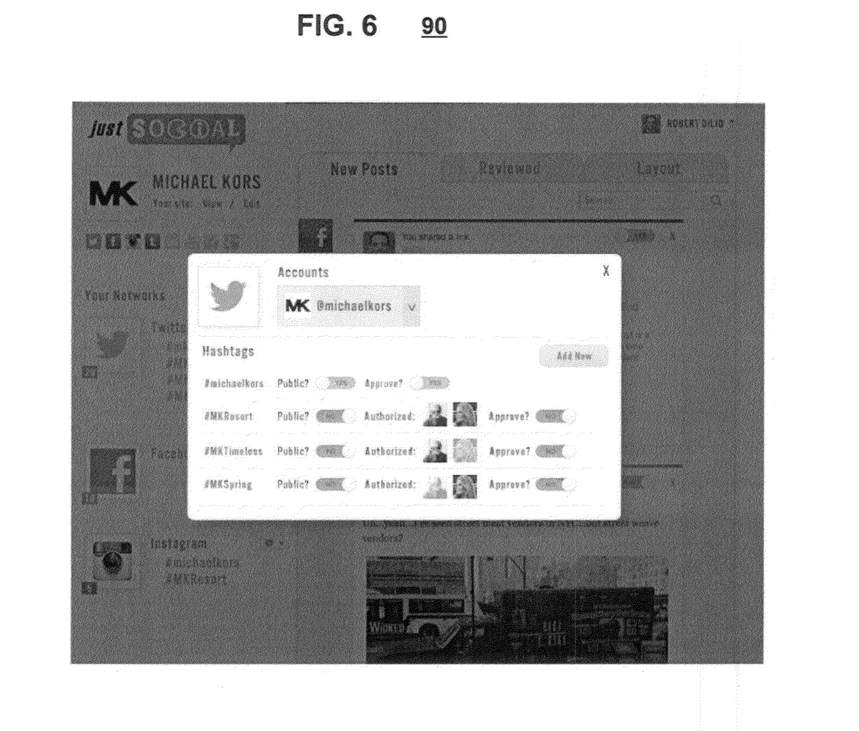

FIG. 5 illustrates a depicts an illustration 80 of curating and approving new posts on a particular website coming from a plurality of social media network sources. In this particular instance, a link posted on Facebook is approved and a photo posted on Facebook is not approved. FIG. 6 depicts another illustration 90 of curating and approving hash tags. Various different accounts can be selected for curating and approving and within each account, particular hash tags can be made public (or private), approved or disapproved, and authorized individuals for approving can be designated. Additional hash tags can also be added with their corresponding options for public/private, approve/disapprove or other options as needed.

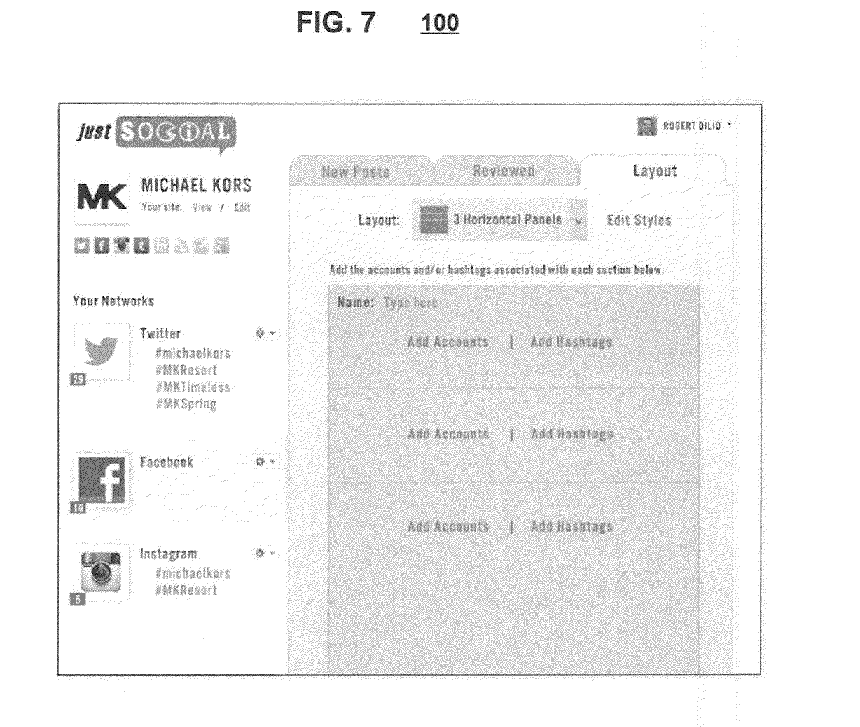

Referring to FIG. 7, the illustration 100 depicts a highlighted layout tab for selecting a particular layout style and for selecting the particular accounts and/or hash tags to populated the selected layout.

In one embodiment, the disclosed system can include a content management system allowing individuals and brands to create either a custom third-party hosted microsite or leverage a widget on their own private site that takes an aggregate of everything that is going on about them or their brand across all the major social media channels. The individuals can also curate the content from across the plurality of social media channels and approve which content they want to display on their website and target specific social network accounts or Hash tags to display in certain sections of their site. The embodiments herein also provide the ability to choose from pre-defined templates or layouts to build their custom microsite and specify which sections in the microsite maps to which Social Networks, Hash tags, or other links. This allows them to post content only once on the social network of their choice and have it either automatically stream in real-time on their site, or show on the site pending approval from someone on their social media marketing team (see FIG. 6).

As noted above, other embodiments can include Social Media Analytics against their data across all social networks. Other options can include sentiment filters allowing users/brand managers to automatically filter content that displays on their site by the sentiment of the post. In one example, a brand manager for a particular brand could decide to allow posts with a positive sentiment to automatically post on their microsite, but might want to first approve all posts that an algorithm thinks are negative or neutral. Other options can include Explicit Language and Pornography Filters. A pornography filter can check images for images including flesh tones and automatically flag them for approval or immediate rejection if they identify pornographic material. Additionally, users can set which explicit language (if any) to allow on their site and have that content automatically rejected.

Other aspects can provide for content management for posting new content. Users will be able to create the social media posts or status updates on a particular website or portal and then have that route through a pre-defined workflow and approval process before automatically posting it to the Social Networks after approval. Thus, in one aspect, the system can utilize a “Pull” approach where the content management system pulls curated and approved content across the social network channels and displays it in an engaging visual fashion. In another aspect, a system herein can also have the ability to approve and “Push” content in an automated (or semi-automated) fashion to the social networks after approval.

User-friendly social media content management systems (push to platforms capability) are very limited in existence. Essentially, an “all-in-one” solution is not currently available to facilitate dynamically generating feed of popular social platforms, filtering of cluttered or unnecessary content, setting parameters around search/display features, including profiles, Public/Private post acceptance, advanced hash tag targeting, and post approval/disapproval functionality. The systems herein provide a more sophisticated social media content management system used to capture news, engagement, and points of view about a brand/service or individual in one place on the web. A unique data analytics tool based on using hash tags and branded keywords to find and link to content around social interests and sentiment on today's most popular social platforms. Other features can include an intelligent nano-targeting search option with user verification.

The system can further include an easy-to-use interface that allows the quick creation of an engaging social media site that is of great use to marketers, developers, and editors due to its incredible ease of use. The interface can include features that enable a user to intuitively work with a user friendly CMS, enable editing and customization of microsite sections right on a page, and zero coding for the user. A user can easily build a custom microsite in minutes or embed a widget into their own website. The advanced nano-targeting tools allow users to perform and save advanced parameters to filter streaming content, create search streams, filter by @mentions, filter by hash tag, filter by social profiles, use smart queries for multiple terms, approve content across all social networks, and enable, real-time or filtered streaming of social content.

Using the system herein make a site differentiator by creating a branded community that combines unique personalized content and experience with the visitors' contributions including social sharing ratings, reviews and other user-generated content. The system also engages with visitors by encouraging visitors to express themselves and interact with the website's company via wikis, forums, and message boards. Furthermore, the system enables users to execute and measure social campaigns by measuring the success of the owners online community efforts. The system delivers the resources and technologies for capturing, organizing, storing, and producing content for an engaging web presence that includes integration services for many third-party tools like Pluck and Telligent for building communities and managing reputation. The system is also an extensible platform that provides application-level services for combining company-driven and user-generated content.

With respect to analytics, the system can track campaign “ROI” by gauging audience reaction and adjust tactics in real-time or by assessing how engaged an online community is with the content being posted across social channels. The system can enable users to easily determine the social posts, designs and messaging that are most popular among a brands target audience, and use those for better business decisions based on what's proven to work well. The system can also provide reliable social marketing reporting and enable the setting of benchmarks and further track the performance of all social media marketing efforts from one central tool. The system can allow a user to subscribe to automatic weekly email reports, or export data to CSV at any time to maintain one's finger on the pulse of a brand's social marketing activity. Other options enable configuring custom notifications that will send e-mail and/or SMS notifications when people engage with the website on social networks based off of sentiment, topics, or particular hash tags.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” “device” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. The medium can also include storage “in the cloud”. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like, However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

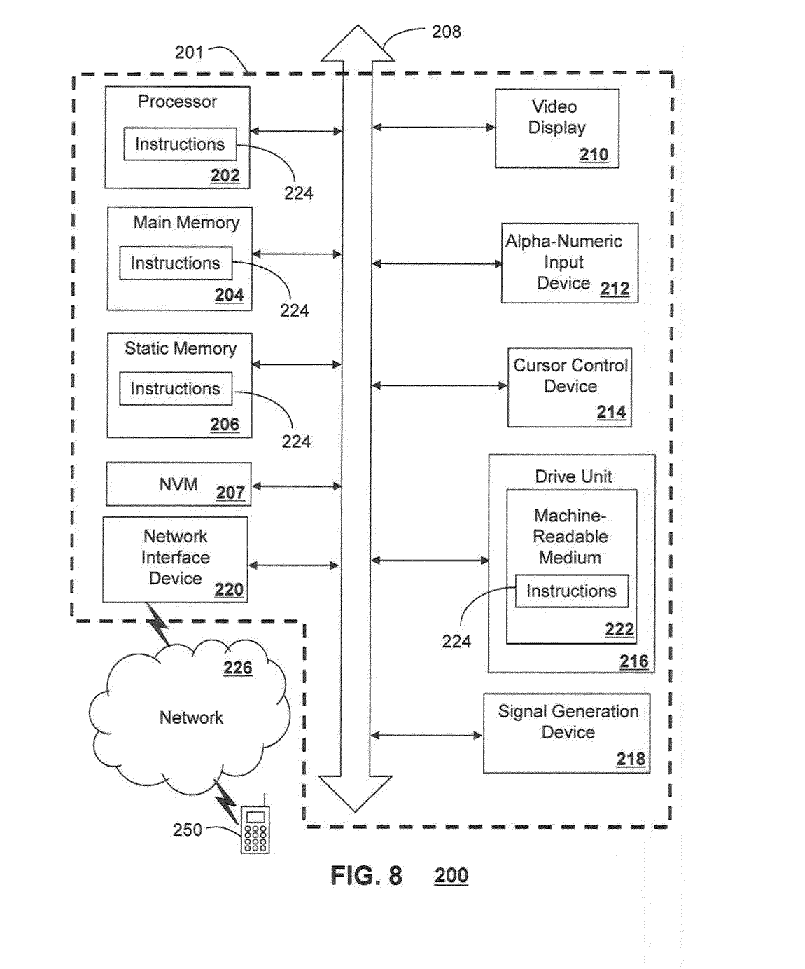

FIG. 8 depicts an exemplary diagrammatic representation of a machine in the form of a computer system 200 within which a set of instructions, when executed, may cause the machine to perform any one or more of the methodologies discussed above. In some or most embodiments herein, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 and more particularly the recipient device 201 can include a controller or processor 202 (e.g., a central processing unit (CPU), a graphics processing unit (GPU, or both), a main memory 204 and a static memory 206 such as DRAM, which communicate with each other via a bus 208. The computer system 200 would further include non-volatile XIP memory or NVM 207 as described in detail above. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, the NVM 207, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of managing content, comprising:
aggregating social networking data from a plurality of social networks on to a website to provide an aggregation of social networking data on the website;
curating the aggregation of social networking data; and
selectively approving content for display on the website from the aggregation of social networking data.

2. The method of claim 1, further comprising targeting social network accounts to display on predetermined sections of the website.

3. The method of claim 1, further comprising targeting hashtags to display on predetermined sections of the website.

4. The method of claim 1, further comprising targeting social network accounts or hashtags to display on predetermined sections of the website.

5. The method of claim 4, further comprising providing pre-defined templates or layouts that enable mapping between predetermined sections of the website and the targeted social network accounts or hashtags.

6. The method of claim 1, further comprising streaming selectively approved content from the aggregation of social media data on to the website.

7. The method of claim 1, further comprising applying social media analytics from the aggregation of social media data from the plurality of social media networks.

8. The method of claim 1, further comprising applying sentiment filters to automatically filter content that displays on the website by a sentiment of a posting obtained from the aggregation of social media data.

9. The method of claim 1, further comprising applying explicit language filters to automatically flag content for approval or immediate rejection.

10. The method of claim 1, further comprising applying pornography filters to automatically flag content for approval or immediate rejection.

11. The method of claim 1, further comprising selectively approving and pushing content to the plurality of networks.

12. A computer system, comprising:
a memory storing computer instructions; and
one or more processors communicatively coupled to the memory, the one or more processors responsive to executing the computer instructions, performs operations comprising:
aggregating social networking data from a plurality of social networks on to a website to provide an aggregation of social networking data on a website;
curating the aggregation of social networking data; and
selectively approving content for display on the website from the aggregation of social networking data.

13. The computer system of claim 12, wherein the one or more processors responsive to executing the computer instructions cause the one or more processors to perform operations comprising targeting social network accounts or hashtags to display on predetermined sections of the website.

14. The computer system of claim 13, wherein the one or more processors responsive to executing the computer instructions cause the one or more processors to perform operations comprising streaming selectively approved content from the aggregation of social media data on to the website.

15. The computer system of claim 12, wherein the one or more processors responsive to executing the computer instructions cause the one or more processors to perform operations comprising applying social media analytics from the aggregation of social media data from the plurality of social media networks.

16. The computer system of claim 12, wherein the one or more processors responsive to executing the computer instructions cause the one or more processors to perform operations comprising applying sentiment filters to automatically filter content that displays on the website by a sentiment of a posting obtained from the aggregation of social media data.

17. The computer system of claim 12, wherein the one or more processors responsive to executing the computer Instructions cause the one or more processors to perform operations comprising applying explicit language filters or pornography filters to automatically flag content for approval or immediate rejection.

18. A non-transitory computer readable storage medium having data stored therein representing software executable by a computer, the software including instructions to manage content from a plurality of social networks, the storage medium comprising:
instructions for aggregating social networking data from a plurality of social networks on to a website to provide an aggregation of social networking data on a website;
instructions for curating the aggregation of social networking data; and
instructions for selectively approving content for display on the website from the aggregation of social networking data.

19. The non-transitory computer readable storage medium of claim 18, the storage medium comprising instructions for targeting social network accounts or hashtags to display on predetermined sections of the website.

20. The non-transitory computer readable storage medium of claim 18, the storage medium comprising instructions for selectively approving and pushing content to the plurality of networks.
